(19) United States
(12) Patent Application Publication
(10) Pub. No.: US 2012/0180762 A1
(43) Pub. Date: Jul. 19, 2012

(54) METHOD FOR DRIVING A SOLENOID VALVE OF A FUEL INJECTOR

(75) Inventor: Paolo CASASSO, Cuneo (IT)

(73) Assignee: GM GLOBAL TECHNOLOGY OPERATIONS LLC, Detroit, MI (US)

(21) Appl. No.: 13/349,186

(22) Filed: Jan. 12, 2012

(30) Foreign Application Priority Data
Jan. 13, 2011 (GB) 1100547.7

(51) Int. Cl. F02D 41/26; F02M 51/00

(52) U.S. Cl. 123/472

(57) ABSTRACT

A battery supplies power to a solenoid valve at a voltage and by a DC/DC boost converter at a boost voltage that is higher than the battery voltage. Operating parameters of the injector are stored that include at least peak high and peak low currents and peak phase duration. A pull-in phase up is performed to current into the solenoid valve when a value greater than the peak high current is reached. Current is monitored into the solenoid and switching on the battery voltage to the solenoid if the current into the solenoid is equal to or lower than, the peak low current, then monitoring the current into the solenoid and powering the solenoid at the boost voltage if the current into the solenoid is still lower than the peak low current. Otherwise powering the solenoid at the battery voltage and performing a hold phase.

### CROSS-REFERENCE TO RELATED APPLICATION

This application claims priority to British Patent Application No. 1100547.7, filed Jan. 13, 2011, which is incorporated herein by reference in its entirety.

### TECHNICAL FIELD

The technical field relates to fuel injection in an internal combustion engine and, in particular, the invention relates to a method for driving a solenoid valve of a fuel injector.

### BACKGROUND

Solenoid valve fuel injectors are provided with solenoid actuators and comprise a valve housing with current coil and electrical connections, a valve seat with a nozzle and a movable valve needle. When such an injector is energized (e.g., a current is sent to the solenoid actuator), the coil generates a magnetic field which lifts the valve needle off of its seat to allow fuel to flow through the injector and to leak out of the nozzle towards the combustion chamber of the associated cylinder. When the injector is de-energized (e.g., the current is no longer sent to the solenoid actuator), the valve needle is pressed against the valve seat. Fuel injectors selected for common rail diesel engines (CR engines) and gasoline direct engines (GDI engines) are current controlled by an electronic control module (ECM).

As known in the art, the profile of the current circulating into the solenoid of the injector is usually divided in a “pull-in” phase, a “peak” phase, and a “hold” phase. During the pull-in phase the current rises up supplied via a dedicated power supply called DC/DC boost converter that provides a voltage between 30V and 65V. Once the pull-in current is detected by the ECM, the voltage is switched off and the current recirculates via ground voltage (i.e., 0 volt).

During the peak phase, the current is average controlled between two preset current levels (“peak high current” and “peak low current”) by switching on and off the power supply to the solenoid: the power supply is typically the battery voltage. The current is similarly controlled in the hold phase between a “hold high current” and a “hold low current”. The manufacturer of the injectors usually provides these preset current levels.

In case the battery voltage is too low, the power supply provided by the battery at the battery voltage is not enough to allow current to rise up to peak high current during the peak phase. In the known art, this condition is usually detected by monitoring the battery voltage: when it happens, the boost voltage supply is also used during the peak period and the current is recirculated via ground voltage. Although this solution allows to reach the peak high current, it introduces several unwanted side effects, namely: electromagnetic issues due to the fact that the period between two consecutive on/off boost power supply pulses becomes very fast; the voltage involved in the switch on/off is higher than the typical battery voltage and then additional power consumption of DC/DC boost converter is requested to provide additional energy to the injector (pull-in phase and peak phase). This also involves increase the power dissipation and the temperature of the injection control module.

At least one object is to provide a method for driving a solenoid valve of a fuel injector that allows proper energizing of the solenoid valve during the peak phase by using the boost power supply only when it is actually needed. At least another object is to provide a method for driving a solenoid valve of a fuel injector that allows limiting the electromagnetic emissions and the power consumption of the injection control module when the solenoid valve is driven by the boost power supply. In addition, other objects, desirable features and characteristics will become apparent from the subsequent summary and detailed description, and the appended claims, taken in conjunction with the accompanying drawings and this background.

### SUMMARY

These objects are achieved with a method for driving a solenoid valve of a fuel injector during an injection phase in an internal combustion engine. Power supplied to the solenoid valve is provided by a battery at a battery voltage with respect to the ground voltage, and by a DC/DC boost converter at a boost voltage which is higher than the battery voltage, and a plurality of parameters relating to the operation of the injector are stored in a memory of an injection control module, the parameters including at least the values of a peak high current, a peak low current and the duration of a peak phase, the method including the steps of: a) performing a pull-in phase up to the current flowing into the solenoid valve has reached a value greater than the peak high current; b) performing a peak phase by monitoring the current flowing into the solenoid valve and switching on the battery voltage to the solenoid valve if the current flowing into the solenoid valve is equal to, or lower than, the peak low current, then monitoring the current flowing into the solenoid valve and powering the solenoid valve at the boost voltage if the current flowing into the solenoid valve is still lower than the peak low current, otherwise powering the solenoid valve at the battery voltage; and c) performing a hold phase. Monitoring the current level rather than the battery voltage allows to take into account of other possible conditions that could affect a proper powering of the solenoid valve, for example when the wiring harness resistance is too high, the injector resistance is too high or, anyway, in case of injector degradation.

According to another embodiment of the method, in the step b), after the battery voltage has been switched on, the current flowing into the solenoid valve is monitored after a pre-set delay time has elapsed from switching on the battery voltage to the solenoid valve. Use of the boost voltage to drive the solenoid valve is thus optimized and power dissipation of the injection control module is consequently limited with respect to the known driving methods.

According to an embodiment, powering the solenoid valve at the boost voltage is performed according to the following steps: b1) switching on the boost voltage to the solenoid valve; b2) holding the boost voltage; b3) monitoring the current flowing into the solenoid valve and switching off the boost voltage applied in step b1) when the detected current has reached a value equal to, or greater than, the peak high current; b4) recirculating the current flowing into solenoid valve via the battery voltage; b5) monitoring the current flowing into the solenoid valve and repeating the steps from b1) to b4) when the detected current has reached a value equal to, or lower than, the peak low current; and b6) repeating the steps from b1) to b5) for all the duration of the peak phase.

It has been found that recirculating the current between the boost voltage and the battery voltage (rather than the ground voltage) allows reducing the switching frequency of the boost voltage. Therefore, a reduction is obtained in electromagnetic emissions.

According to another embodiment, a computer program is provided which comprises computer executable codes for driving a solenoid valve of a fuel injector during an injection phase in an internal combustion engine. A power supply is provided to the solenoid valve by a battery at a battery voltage with respect to the ground voltage and by a DC/DC boost converter at a boost voltage that is higher than the battery voltage. The computer program, stored in a computer readable medium, includes a computer executable code for reading a plurality of parameters relating to the operation of the injector that are stored in a memory of an injection control module, the parameters including at least the values of a peak high current, a peak low current and the duration of a peak phase; a computer executable code for performing an injection phase including a sequence of a pull-in phase, a peak phase and a hold phase; a computer executable code for performing the pull-in phase up to the current flowing into the solenoid valve has reached a value greater than the peak high current; a computer executable code for performing the peak phase by monitoring the current flowing into the solenoid valve and switching on the battery voltage to the solenoid valve if the current flowing into the solenoid valve is equal to, or lower than, the peak low current, then monitoring the current flowing into the solenoid valve and powering the solenoid valve at the boost voltage if the current flowing into the solenoid valve is still lower than the peak low current, otherwise powering the solenoid valve at the battery voltage; and a computer executable code for performing the hold phase. The computer program can be further provided with a computer executable code to monitor the current monitored after a pre-set delay time has elapsed from switching on the battery voltage to the solenoid valve.

Preferably, the computer program further includes computer executable codes for powering the solenoid valve at the boost voltage which include: b1) a computer executable code for switching on the boost voltage to the solenoid valve; b2) a computer executable code for holding the boost voltage; b3) a computer executable code for monitoring the current flowing into the solenoid valve and switching off the boost voltage when the detected current has reached a value equal to, or greater than, the peak high current; b4) a computer executable code for recirculating the current flowing into solenoid valve via the battery voltage; b5) a computer executable code for monitoring the current flowing into the solenoid valve and repeating the computer executable codes from b1) to b4) when the detected current has reached a value equal to, or lower than, the peak low current; and b6) a computer executable code for repeating the computer executable codes from b1) to b5) for all the duration of the peak phase.

According to a further embodiment, an injection control module is provided for an internal combustion engine comprising a microprocessor and a storage memory for storing a computer program as stated above. The computer program comprises computer executable codes for driving a solenoid valve of a fuel injector during an injection phase in an internal combustion engine, the microprocessor being able to receive and to execute the computer executable codes of the computer program.

### BRIEF DESCRIPTION OF THE DRAWINGS

The present invention will hereinafter be described in conjunction with the following drawing figures, wherein like numerals denote like elements, and:

FIG. 1 shows two graphs representing the time developments of the voltage applied to the solenoid valve of a fuel injector and the corresponding profile of the current flowing into the solenoid valve in normal operating conditions;

FIG. 2 shows two graphs representing the time developments of the voltage applied to the solenoid valve of a fuel injector and the corresponding profile of the current flowing into the solenoid valve in condition of low battery voltage;

FIG. 3 shows two graphs representing the time developments of the voltage applied to the solenoid valve of a fuel injector and the corresponding profile of the current flowing into the solenoid valve according to the prior art;

FIG. 4A and FIG. 4B are flow charts of the driving method according to exemplary embodiments;

FIG. 5 is a detailed flow chart of one of the blocks shown in FIG. 4A and FIG. 4B;

FIG. 6 is a detailed flow chart of another block shown in FIG. 4A and FIG. 4B;

FIG. 7 shows two graphs representing the time developments of the voltage applied to the solenoid valve of a fuel injector and the corresponding profile of the current flowing into the solenoid valve according to an embodiment of the driving method; and

FIG. 8 is a block diagram showing an injection control module operating according to an embodiment.

### DETAILED DESCRIPTION

The following detailed description is merely exemplary in nature and is not intended to limit application and uses. Furthermore, there is no intention to be bound by any theory presented in the preceding background or the following detailed description.

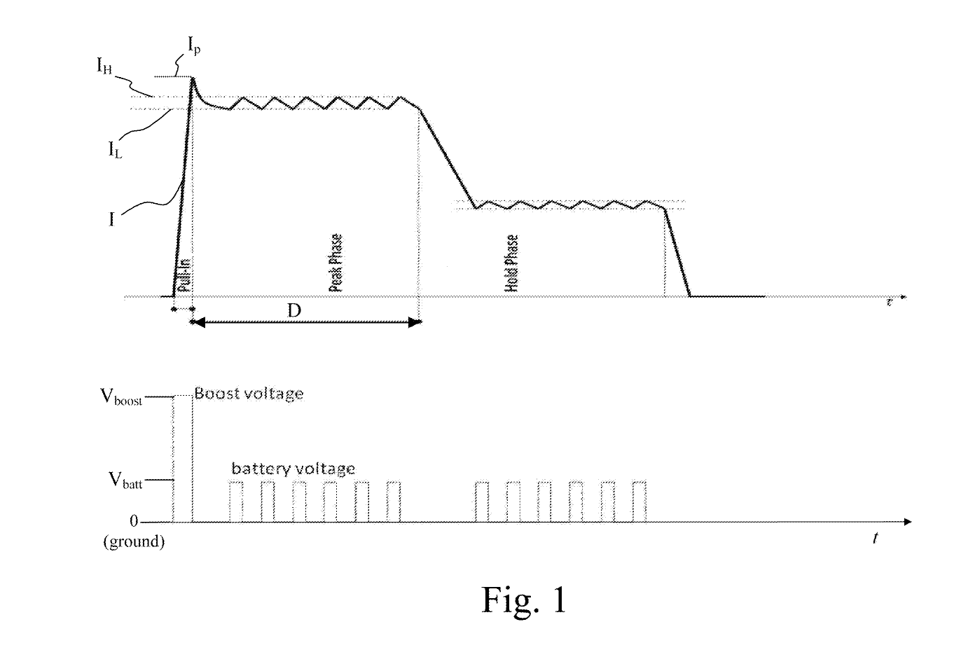

As shown in FIG. 1, with reference to the profile of the current circulating into the solenoid valve of the injector, a single injection is usually divided in a “pull-in” phase, a “peak” phase and a “hold” phase. During the pull-in phase the solenoid valve is powered at a voltage V_{boost} between supplied by a DC/DC boost converter in order to rise up the current until it reaches a value equal to, or greater than, the pull-in current Iₚ. Once the pull-in current is detected by the injection control module, the voltage V_{boost} is switched off and the current recirculates into the solenoid valve via the ground voltage (0 volts).

The pull-in phase is followed by the peak phase, in which the current is average controlled between a peak high current I_{H} and a peak low current I_{L}. In the normal operating conditions shown in FIG. 1, i.e., when the battery is fully charged, the current is maintained between the values I_{L} and I_{H} by switching on and off the power supply provided by the battery at a voltage V_{batt} which is sufficient to maintain the current between the two preset levels I_{H} and I_{L} for all the duration D of the peak phase.

Then in the hold phase, the current is controlled in a similar way between a “hold high current” and a “hold low current”. In these phase the pressure of the fuel flowing through the injector exerts a strong force on the valve needle: the current required to maintain this condition is lesser than that in the old phase and can be provided by the battery even in a condition of low voltage.

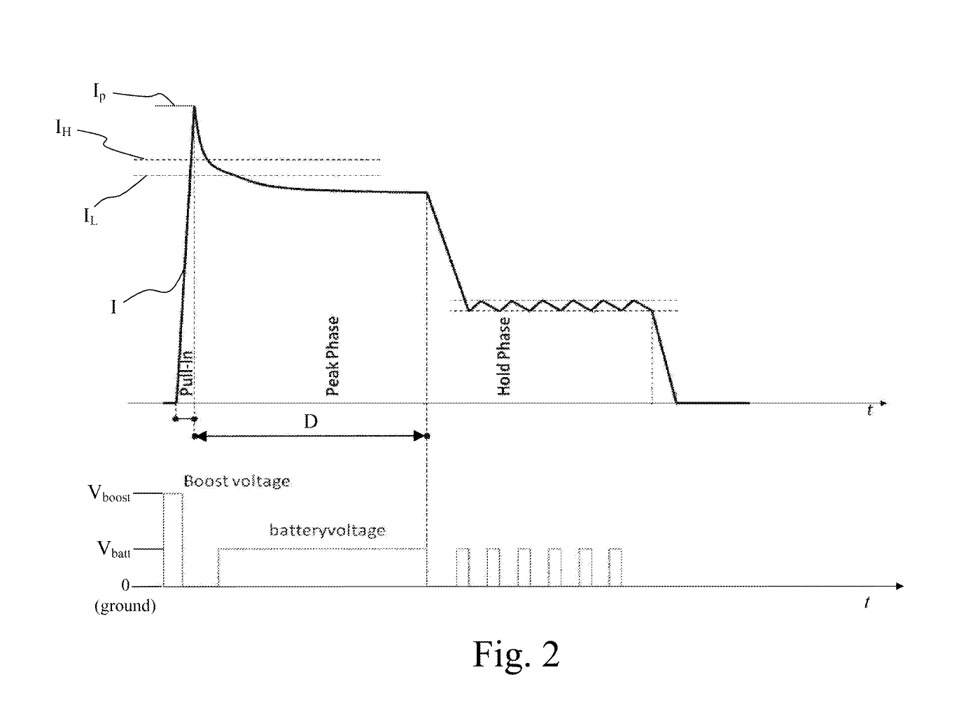

For these reasons, problems arise in the peak phase when the battery voltage V_{batt} is too low for maintaining the current between the preset levels I_{H} and I_{L}. A schematic example of this condition is shown in the graphs of FIG. 2 in which, after the pull-in phase, the current does not rise up to the peak high current I_{H} and falls down below the peak low current I_{L} although the battery voltage V_{batt} is continuously applied to the solenoid valve. Moreover, it should be taken into account that the behavior shown in FIG. 2 can also be due not only to a low battery voltage, but also to other causes such as a high wiring harness resistance, a high injector resistance or the like. Because of this behavior, the amount of fuel injected cannot be properly controlled.

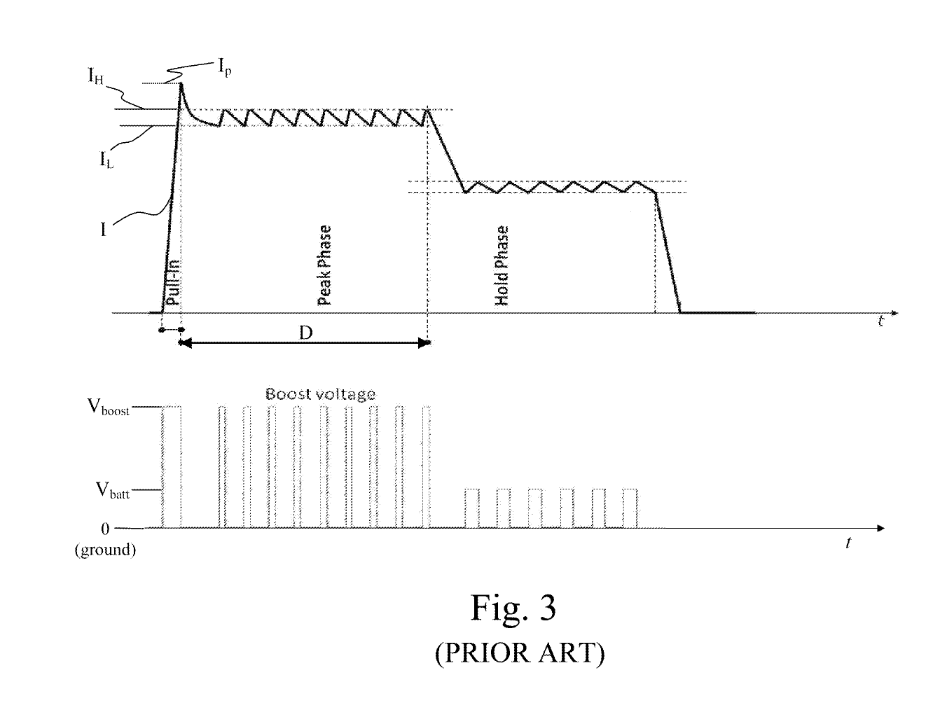

In order to overcome this drawback, the boost voltage V_{boost} is usually applied to the solenoid valve for all the duration D of the peak phase as shown in FIG. 3. The driving is performed in a similar way to that shown in FIG. 1 with voltage V_{boost}—instead of V_{batt}—switched on and off to the solenoid valve to maintain the current between the two levels I_{H} and I_{L}. When the voltage V_{boost} is switched off, the current flowing into the solenoid valve is recirculated via the ground voltage, usually at 0 volts. As already stated, this traditional solution allows reaching the peak high current but involves electromagnetic issues and an increase in the power dissipation of the injection control module.

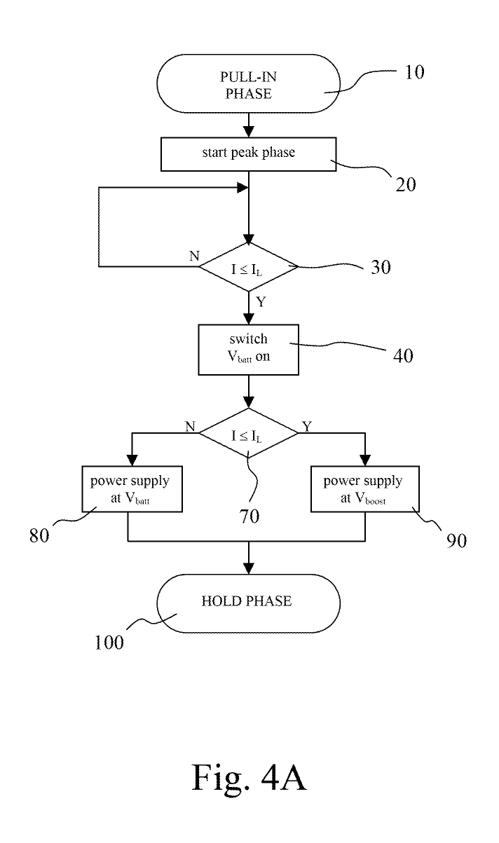

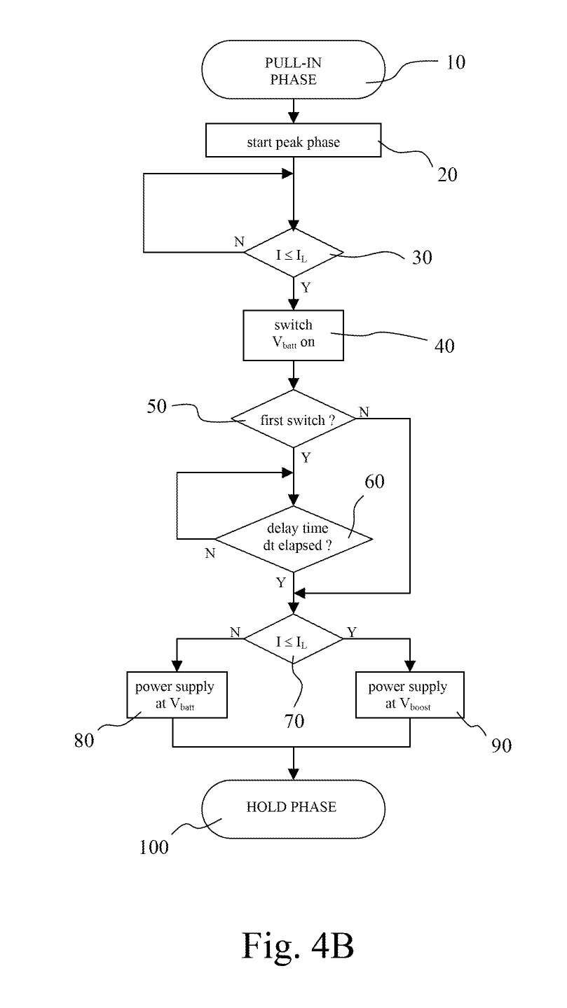

An embodiment of the method is shown in FIG. 4A under the form of a flow chart. After the pull-in phase 10, in which the current flowing into the solenoid valve has reached a value greater than the peak high current Iₚ (FIGS. 1-3), the peak phase is started at block 20. The current flowing into the solenoid valve is monitored at the decision block 30 in order to detect if the current I flowing into the solenoid valve is equal to, or lower than, the peak low current I_{L}. If the current is still over the value I_{L}, the monitoring of the current at the decision block 30 is performed again. This is only a schematic representation of the procedure to monitor the current: from a practical point of view, monitoring of the current I is performed continuously by a comparator device which receives in input the value of the current I and the pre-set value I_{L} previously stored in a memory of the injection control module. Moreover, although not represented in this and the subsequent flow charts, all the durations of time intervals such as the duration D of the peak phase and any possible delay time introduced into the control flow (e.g., delay time dt in FIG. 4B), are assumed to be controlled, for example, on the basis of the clock of a microprocessor of the injection control module.

If the current I flowing into the solenoid valve is fallen down to a value equal to, or lower than, the peak low current I_{L}, then the battery voltage V_{batt} is switched on to the solenoid valve (block 40). A this point, with only the battery voltage V_{batt} applied to the solenoid valve, the detection of a current I which is still over the level I_{L} means that the peak phase can be performed by powering the solenoid valve at the V_{batt} voltage (block 80) and therefore the current and voltage profiles are those already shown on FIG. 1.

Another embodiment of the method is shown in FIG. 4B. The control flow is substantially the same of the embodiment of FIG. 4A. However, after switching on the battery voltage V_{batt} in block 40, a check is performed in the decision block 50, for example by reading the value of a flag, to know whether it is the first switch of the battery voltage V_{batt} in the peak phase. In the positive, a delay is introduced (decision bock 60) for a pre-set delay time—for example from 10 to 30 μsec—before monitoring again the current I flowing into the solenoid valve in the decision block 70.

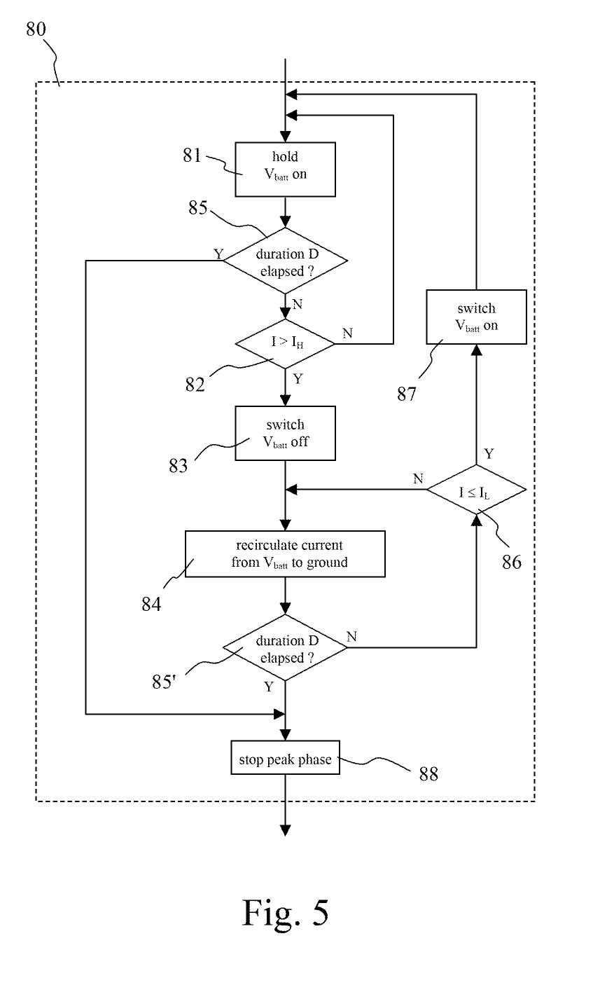

A detailed view of the steps executed within block 80 is shown on the flow chart of FIG. 5. The voltage V_{batt} previously switched on is maintained (block 81) and a check is performed to determine if the current control is still in the peak phase (decision block 85. If the duration D is elapsed, the control flow skips at the end of the peak phase at block 88, otherwise the voltage V_{batt} is maintained until the current I reaches a value greater than the peak high current I_{H} (decision block 82). When it happens, the voltage V_{batt} is switched off (block 83) and the current I is recirculated from V_{batt} to ground voltage (block 84).

If the duration D of the peak phase has not been reached yet (decision block 85′), the current I is recirculated until it falls down below the peak low current (decision block 86): when this condition is verified, the voltage V_{batt} is switched on again and the control flow goes back to block 81. Otherwise, if the duration D has been reached, the peak phase is terminated (block 88) and the control flow proceeds to block 100 of FIG. 4A or FIG. 4B to perform the hold phase. Back to FIG. 4, if the voltage V_{batt} applied to the solenoid valve is not sufficient to maintain the current I between the peak high current I_{H} and the peak low current I_{L}: the solenoid valve must be powered by the V_{boost} voltage (block 90).

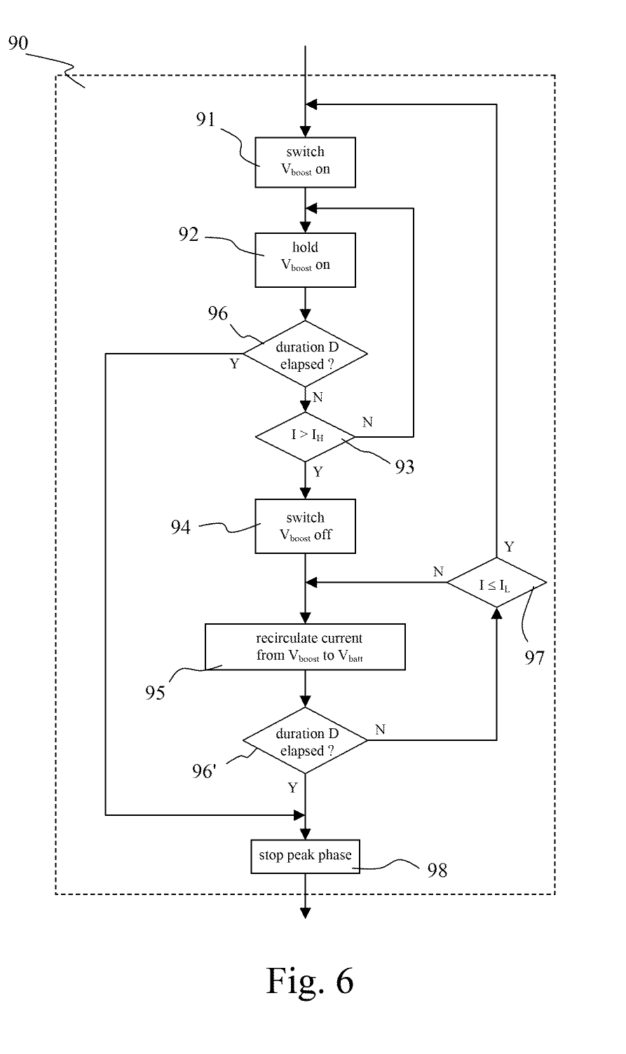

A detailed view of the steps executed within block 90 is shown on the flow chart of FIG. 6. The voltage V_{boost} is switched on (block 91) and maintained (block 92). A check is performed to determine if the current control is still in the peak phase (decision block 96): if the duration D is elapsed, the control flow skips at the end of the peak phase at block 98, otherwise the voltage V_{boost} is maintained until the current I reaches a value greater than the peak high current I_{H} (decision block 93). When it happens, the voltage V_{boost} is switched off (block 94) and the current I is recirculated from V_{boost} to V_{batt} (block 95).

If the duration D of the peak phase has not been reached yet (decision block 96′), the current I is recirculated until it falls down below the peak low current (decision block 97): when this condition is verified, the voltage V_{boost} is switched on again and the control flow goes back to block 91. Otherwise, if the duration D has been reached, the peak phase is terminated (block 98) and the control flow proceeds to block 100 of FIG. 4A or FIG. 4B to perform the hold phase.

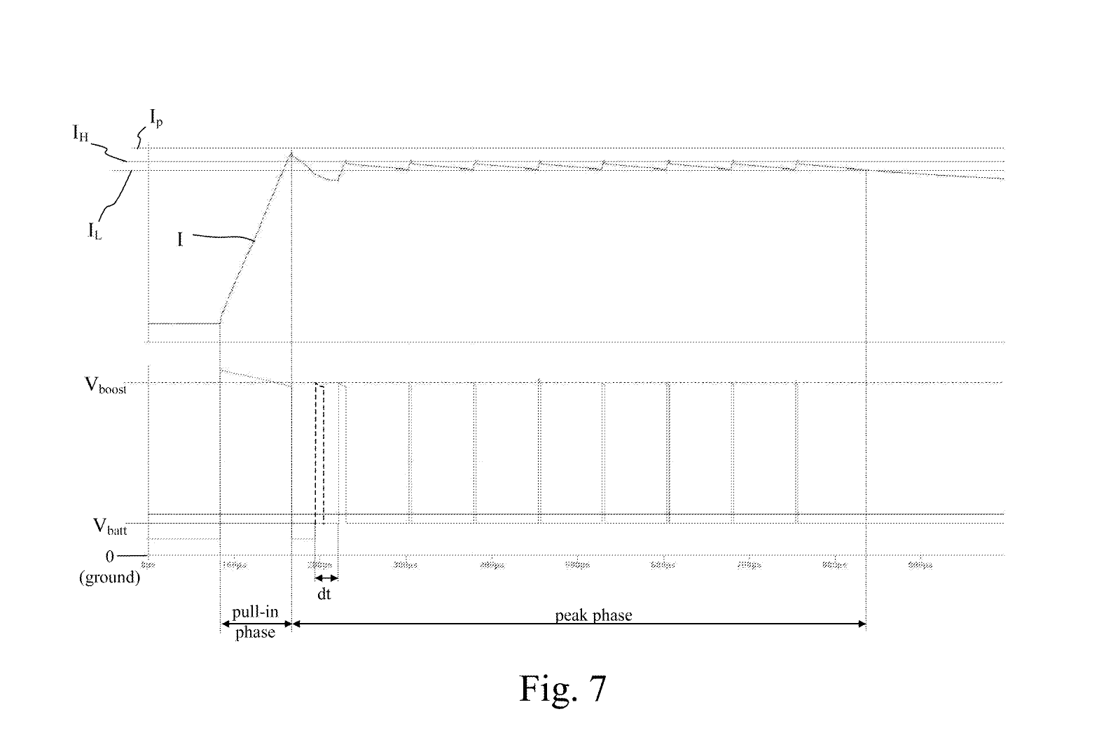

FIG. 7 shows two graphs representing the profiles of voltage and current in the pull-in and peak phases according to the embodiments of the method previously disclosed with reference to FIG. 4A, FIG. 4B and FIG. 6.

After the pull-in phase, the current I decreases and, when it reaches the peak low current I_{L}, the battery voltage V_{batt} is firstly applied to the solenoid valve before the voltage V_{boost}. The latter can be applied immediately (pulse in dotted line) according to the embodiment of the method disclosed in FIG. 4A, or after a pre-set delay time dt has been elapsed from switching the V_{batt} voltage on according to the embodiment of the method disclosed with reference to FIG. 4B.

It should be noted from the voltage profile that, after switching off the voltage V_{boost}, the solenoid valve remains powered by the voltage V_{batt} before a subsequent switching on of the boost voltage. This means that the current I flowing into the solenoid valve is recirculated between V_{boost} and V_{batt} in order to reduce the frequency of the pulses at the boost voltage.

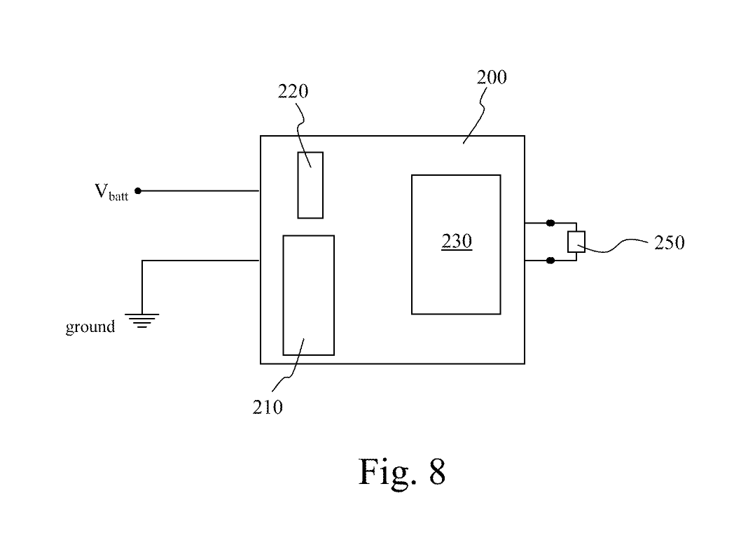

FIG. 8 shows an injection control module 200 to perform the method of the embodiments disclosed above. Module 200 is powered by the battery voltage and includes a microprocessor 210, a memory unit 220 and a hardware device 230 including for example a DC/DC boost converter and the circuit to monitor the current I flowing into the injector 250. The memory unit 220 can be also integrated into the microprocessor 210.

The embodiments of the methods described above may be carried out with the help of a computer program comprising a program code or computer readable instructions for carrying out all the method steps described above. The computer program can be stored on a data carrier or, in general, a computer readable medium or storage unit, to represent a computer program product. The storage unit may be a CD, DVD, a hard disk, a flash memory, or the like.

The computer program can be also embodied as an electromagnetic signal, the signal being modulated to carry a sequence of data bits that represent a computer program to carry out all steps of the methods. The computer program may reside on or in a data carrier, e.g., a flash memory, which is data connected with a control apparatus for an internal combustion engine. The control apparatus has a microprocessor that receives computer readable instructions in form of parts of said computer program and executes them. Executing these instructions amounts to performing the steps of the method as described above, either wholly or in part.

The injection control module or, in general, an ECA (Electronic Control Apparatus) can be a dedicated piece of hardware such as an ECU (Electronic Control Unit), which is commercially available and thus known in the art, or can be an apparatus different from such an ECU, e.g., an embedded controller. If the computer program is embodied as an electromagnetic signal as described above, then the electronic control apparatus, e.g., the ECU, has a receiver for receiving such a signal or is connected to such a receiver placed elsewhere. The signal may be transmitted by a programming robot in a manufacturing plant. The bit sequence carried by the signal is then extracted by a demodulator connected to the storage unit, after which the bit sequence is stored on or in said storage unit of the ECA.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. A method for driving a solenoid valve of a fuel injector during an injection phase in an internal combustion engine with a power supply provided to the solenoid valve by a battery at a battery voltage with respect to a ground voltage and by a DC/DC boost converter at a boost voltage that is higher than the battery voltage, and a plurality of parameters relating to operation of the fuel injector are stored in a memory of an injection control module, the plurality of parameters including at least values of a peak high current, a peak low current, and a duration of a peak phase, the method comprising:
performing a pull-in phase up to a current flowing into the solenoid valve that has reached a value greater than said peak high current;
performing the peak phase by monitoring the current flowing into the solenoid valve and switching on the battery voltage to the solenoid valve if the current flowing into the solenoid valve is less than or equal to said peak low current, then monitoring the current flowing into the solenoid valve and powering the solenoid valve at the boost voltage if the current flowing into the solenoid valve is still lower than said peak low current, otherwise powering the solenoid valve at the battery voltage; and
performing a hold phase.

2. The method according to claim 1 wherein, in said performing the peak phase, after the battery voltage has switched on, the current flowing into the solenoid valve is monitored after a pre-set delay time has elapsed from switching on the battery voltage to the solenoid valve.

3. The method according to claim 1, wherein powering the solenoid valve at the boost voltage comprises:
switching on the boost voltage to the solenoid valve;
holding the boost voltage;
monitoring the current flowing into the solenoid valve and switching off said boost voltage applied in the switching on the boost voltage to the solenoid valve when the current has reached a value that is greater than or equal to said peak high current;
recirculating the current flowing into the solenoid valve via the battery voltage;
monitoring the current flowing into the solenoid valve and repeating said the switching, the holding, the monitoring, the recirculating, and the monitoring when the current has reached a value that is less than or equal to said peak low current; and
repeating the switching, the holding, the monitoring, the recirculating, and the monitoring for all the duration of said peak phase.

4. A computer readable medium embodying a computer program product, the computer program product comprising:
a driving program for driving a solenoid valve of a fuel injector during an injection phase in an internal combustion engine with a power supply provided to the solenoid valve by a battery at a battery voltage with respect to a ground voltage and by a DC/DC boost converter at a boost voltage that is higher than the battery voltage, and a plurality of parameters relating to operation of the fuel injector are stored in a memory of an injection control module, the plurality of parameters including at least values of a peak high current, a peak low current, and a duration of a peak phase, the driving program configured to:
perform a pull-in phase up to a current flowing into the solenoid valve that has reached a value greater than said peak high current;
perform the peak phase by monitoring the current flowing into the solenoid valve and switching on the battery voltage to the solenoid valve if the current flowing into the solenoid valve is less than or equal to said peak low current, then monitoring the current flowing into the solenoid valve and powering the solenoid valve at the boost voltage if the current flowing into the solenoid valve is still lower than said peak low current, otherwise powering the solenoid valve at the battery voltage; and
perform a hold phase.

5. The computer readable medium embodying the computer program product according to claim 4, wherein, the driving program is configured to perform the peak phase, after the battery voltage has switched on, the current flowing into the solenoid valve is monitored after a pre-set delay time has elapsed from switching on the battery voltage to the solenoid valve.

6. The computer readable medium embodying the computer program product according to claim 4, wherein the driving program is configured to power the solenoid valve at the boost voltage by:
switching on the boost voltage to the solenoid valve;
holding the boost voltage;
monitoring the current flowing into the solenoid valve and switching off said boost voltage applied in the switching on the boost voltage to the solenoid valve when the current has reached a value equal to, or greater than, said peak high current;
recirculating the current flowing into the solenoid valve via the battery voltage;
monitoring the current flowing into the solenoid valve and repeating said the switching, the holding, the monitoring, the recirculating, and the monitoring when the current has reached a value that is less than or equal to said peak low current; and
repeating the switching, the holding, the monitoring, the recirculating, and the monitoring for all the duration of said peak phase.

7. An injection control module for an internal combustion engine, comprising:
a fuel injector in the internal combustion engine having an injection phase;
a solenoid valve of the fuel injector during the injection phase in the internal combustion engine; and
a processor configured to drive the solenoid valve, the processor further configured to:
perform a pull-in phase up to a current flowing into the solenoid valve that has reached a value greater than a peak high current;
perform a peak phase by monitoring the current flowing into the solenoid valve and switching on a battery voltage to the solenoid valve if the current flowing into the solenoid valve is less than or equal to a peak low current, then monitoring the current flowing into the solenoid valve and powering the solenoid valve at a boost voltage if the current flowing into the solenoid valve is still lower than said peak low current, otherwise powering the solenoid valve at the battery voltage; and
perform a hold phase.

8. The injection control module for an internal combustion engine according to claim 7, wherein, the processor is further configured to perform the peak phase, after the battery voltage has switched on, the current flowing into the solenoid valve is monitored after a pre-set delay time has elapsed from switching on the battery voltage to the solenoid valve.

9. The injection control module for an internal combustion engine according to claim 7, wherein the processor is configured to power the solenoid valve at the boost voltage by:
switching on the boost voltage to the solenoid valve;
holding the boost voltage;
monitoring the current flowing into the solenoid valve and switching off said boost voltage applied in the switching on the boost voltage to the solenoid valve when the current has reached a value equal to, or greater than, said peak high current;
recirculating the current flowing into the solenoid valve via the battery voltage;
monitoring the current flowing into the solenoid valve and repeating said the switching, the holding, the monitoring, the recirculating, and the monitoring when the current has reached a value that is less than or equal to said peak low current; and
repeating the switching, the holding, the monitoring, the recirculating, and the monitoring for all a duration of said peak phase.
